(19) United States
(12) Patent Application Publication
(10) Pub. No.: US 2020/0353656 A1
(43) Pub. Date: Nov. 12, 2020

(54) MOLDING PROCESS FOR JOINING PREFABRICATED WORKPIECE SUBSTRATES INTO A WORKPIECE ASSEMBLY

(71) Applicant: GM GLOBAL TECHNOLOGY OPERATIONS LLC, Detroit, MI (US)

(72) Inventors: David A. Okonski, Waterford, MI (US); Ryan Gergely, Fraser, MI (US); Blair E. Carlson, Ann Arbor, MI (US); William R. Rodgers, Bloomfield Township, MI (US)

(21) Appl. No.: 16/404,731

(22) Filed: May 6, 2019

(51) Int. Cl. B29C 45/14

(52) U.S. Cl. CPC B29C 45/14467; B29K 2101/12

(57) ABSTRACT

A method of joining a first workpiece substrate and a second workpiece substrate is disclosed in which a local mold tool is positioned into contact with the first workpiece substrate and the second workpiece substrate. The local mold tool defines a mold cavity and encloses an edge portion of the first workpiece substrate and an edge portion of the second workpiece substrate such that the edge portion of the first workpiece substrate and the edge portion of the second workpiece substrate are contained within the mold cavity. Once the local mold tool is positioned, a liquid polymer molding compound is injected into the mold cavity. The liquid polymer molding compound is hardened in the mold cavity into a polymer joint that adheres the edge portion of the first workpiece substrate and the edge portion of the second workpiece substrate together.

### INTRODUCTION

Certain articles of manufacture are constructed from multiple workpiece assemblies. Each of the individual workpiece assemblies may include two or more prefabricated workpiece substrates that need to be joined together. One of the prefabricated workpiece substrates may be formed of a composite material having a thermoplastic or thermoset polymer matrix along with a reinforcement phase, such as certain reinforcing fibers or filler particles, distributed throughout the polymer matrix. The joining of one composite material workpiece substrate to another workpiece substrate—whether the other workpiece substrate is also formed from a composite material or a metal—has typically required the use of mechanical fasteners such as solid rivets, flow drill screws, blind rivets, etc. But puncturing the workpiece substrates with mechanical fasteners exposes and locally damages the polymer matrix and the reinforcement phase of the workpiece substrate(s). This may result in the fatigue strength of one or both of the workpiece substrates being adversely impacted. Other joining techniques including the use of ultrasonic welding and the application of adhesives are available but tend to be inefficient on a mass production scale and, in the case of adhesives, may emit VOCs into the surrounding environment. New and effective ways for joining prefabricated workpiece substrates when at least one of those substrates is formed of a composite material are therefore needed.

### SUMMARY OF THE DISCLOSURE

A method of joining workpiece substrates to form a workpiece assembly according to one implementation of the present disclosure includes several steps. In one step, a local mold tool is positioned into contact with a first workpiece substrate and a second workpiece substrate. The local mold tool defines a mold cavity in conjunction with the first and second workpiece substrates and further encloses an edge portion of the first workpiece substrate and an edge portion of the second workpiece substrate such that the edge portion of the first workpiece substrate and the edge portion of the second workpiece substrate are contained within the mold cavity. In another step, a liquid polymer molding compound is injected into the mold cavity. The liquid polymer molding compound flows through and fills the mold cavity and, further, contacts each of the edge portion of the first workpiece substrate and the edge portion of the second workpiece substrate. In yet another step, the liquid polymer molding compound is hardened into a polymer joint that adheres the edge portion of the first workpiece substrate and the edge portion of the second workpiece substrate together.

The method according to the aforementioned implementation may include additional steps or be further defined. For example, in one variation, the liquid polymer molding compound may fill a gap between the edge portion of the first workpiece substrate and the edge portion of the second workpiece substrate when injected into the mold cavity. As another example, at least one of the first workpiece substrate or the second workpiece substrate may be composed of a composite material that comprises a polymer matrix and a reinforcement phase embedded within and dispersed throughout the polymer matrix. In yet another example, each of the first workpiece substrate and the second workpiece substrate is separately composed of the composite material, and the composite material of the first workpiece substrate and the composite material of the second workpiece substrate may be the same or different.

The edge portions of the first workpiece substrate and the second workpiece substrate may be oriented in various arrangements within the context of the method according to the aforementioned implementation. In one configuration, the edge portion of the first workpiece substrate and the edge portion of the second workpiece substrate may be oriented in a butt joint arrangement in which the edge portions are opposed but do not overlap. In another configuration, the edge portion of the first workpiece substrate and the edge portion of the second workpiece substrate may be oriented in a lap joint arrangement in which the edge portions overlap. In still another configuration, which is a modification of the lap joint arrangement, one of the edge portion of the first workpiece substrate or the edge portion of the second workpiece substrate defines a series of holes that traverse a thickness of the workpiece substrate in which the series of holes are defined.

The liquid polymer molding compound injected into the mold cavity may encompass a variety of formulations within the context of the method according to the aforementioned implementation. For example, the hardening of the liquid polymer molding compound may result in the polymer joint comprising a solid structural engineering plastic selected from the group consisting of a polyamide, a polyurethane, a polyurea, and an epoxy. In one version, the liquid polymer molding compound may be a polymer composition that comprises a molten thermoplastic polymer heated to a temperature above its melting temperature. The hardening of such a polymer composition into the polymer joint may involve allowing the molten thermoplastic polymer to cool to a temperature below its melting temperature within the mold cavity. In another version, the liquid polymer molding compound may be a polymerizable composition that includes reactive polymerizable molecules that are polymerizable into a thermoplastic or thermoset polymer. The hardening of such a polymerizable composition may involve allowing the reactive polymerizable molecules to polymerize within the mold cavity and, if a thermoset polymer is being formed, to also cure. And, regardless of the formulation of the liquid polymer molding compound, the polymer joint may further mechanically interlock the edge portion of the first workpiece substrate and the edge portion of the second workpiece substrate.

A method of joining workpiece substrates to form a workpiece assembly according to another implementation of the present disclosure includes several steps. In one step, a first mold plate and a second mold plate are closed to enclose an edge portion of a first workpiece substrate and an edge portion of a second workpiece substrate. The first mold plate and the second mold plate, when closed, define a mold cavity in conjunction with the first and second workpiece substrates. The edge portion of the first workpiece substrate and the edge portion of the second workpiece substrate are contained within the mold cavity. In another step, a liquid polymer molding compound is injected into the mold cavity. The liquid polymer molding compound flows through and fills the mold cavity and, further, contacts each of the edge portion of the first workpiece substrate and the edge portion of the second workpiece substrate. The liquid polymer molding compound comprises (i) a polymer composition that includes a molten thermoplastic polymer or (2) a polymerizable composition that includes reactive polymerizable molecules that are polymerizable into a thermoplastic or a thermoset polymer. In yet another step, the liquid polymer molding compound is hardened into a polymer joint that adheres the edge portion of the first workpiece substrate and the edge portion of the second workpiece substrate together. The polymer joint comprises a solid structural engineering plastic selected from the group consisting of a polyamide, a polyurethane, a polyurea, and an epoxy.

The method according to the aforementioned implementation may include additional steps or be further defined. For example, each of the first workpiece substrate and the second workpiece substrate may be separately composed of the composite material, and the composite material of the first workpiece substrate and the composite material of the second workpiece substrate may be the same or different. As another example, the liquid polymer molding compound may fill a gap between the edge portion of the first workpiece substrate and the edge portion of the second workpiece substrate when injected into the mold cavity. Consequently, the polymer joint may occupy the same gap when the liquid polymer molding compound is hardened into the polymer joint. In still another example, the polymer joint may further mechanically interlock the edge portion of the first workpiece substrate and the edge portion of the second workpiece substrate.

### BRIEF DESCRIPTION OF THE DRAWINGS

FIG. 1 is a perspective view of a workpiece assembly that includes two workpiece substrates joined together by a polymer joint according to one embodiment of the present disclosure;

FIG. 2 is a cross-sectional view of portions of the first and second workpiece substrates and a local mold tool that has been positioned to enclose end portions of the first and second workpiece substrates during a method of joining the workpiece substrates according to one embodiment of the present disclosure;

FIG. 3 is a cross-sectional view of portions of the first and second workpiece substrates and a liquid polymer molding compound that is being injected into a local mold tool defined by the local mold tool and the first and second workpiece substrates during a method of joining the workpiece substrates according to one embodiment of the present disclosure;

FIG. 4 is a cross-sectional view of portions of the first and second workpiece substrates and the local mold tool after the polymer joint has been formed between the first and second workpiece substrates and the mold tool has been separated from the workpiece substrates according to one embodiment of the present disclosure;

FIG. 5 is a cross-sectional view of portions of the first and second workpiece substrates and the local mold tool, along with an injected liquid polymer molding compound and the polymer joint formed therefrom for the sake of brevity, according to another embodiment of the present disclosure; and

FIG. 6 is a cross-sectional view of portions of the first and second workpiece substrates and the local mold tool, along with an injected liquid polymer molding compound and the polymer joint formed therefrom for the sake of brevity, according to yet another embodiment of the present disclosure.

### DETAILED DESCRIPTION

The present disclosure is directed to a method of joining first and second workpiece substrates into a workpiece assembly when at least one, and preferably both, of the workpiece substrates is formed of a composite material. The method involves positioning a local mold tool around adjacent end portions of the first and second workpiece substrates. The mold tool encloses the end portions of the first and second workpiece substrates and, together with the workpiece substrates, defines a mold cavity. A polymer molding compound is then injected into the mold cavity and hardened into a polymer joint that adheres the edge portion of the first workpiece substrate and the edge portion of the second workpiece substrate together. The local mold tool is subsequently removed from the now-joined workpiece substrates. The joining method is quick, reliable, and can be used with a variety of stacking arrangements of the end portions of the first and second workpiece substrates including a butt arrangement, a lap arrangement, and a modified lap arrangement referred to as a stitch arrangement. Additionally, the disclosed joining method creates a solid, non-dissolvable polymer joint that obviates the need to use mechanical fasteners to join the workpiece substrates and does not release byproduct VOCs.

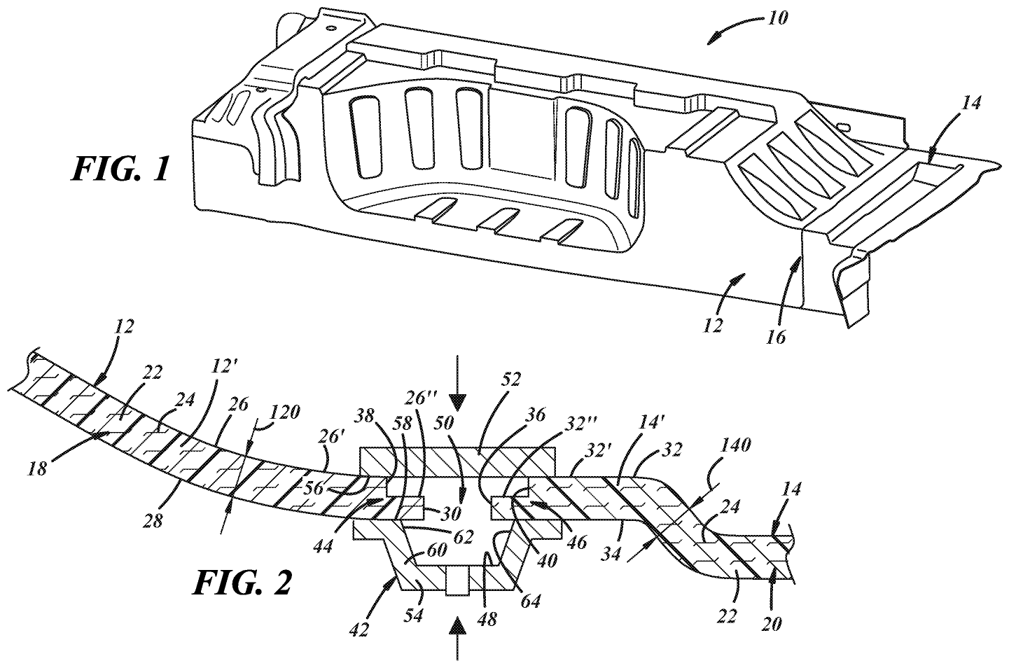

Referring now to FIG. 1, a workpiece assembly 10 that constitutes part of a motor vehicle is illustrated. The workpiece assembly 10 is comprised of multiple prefabricated workpiece substrates that are joined together. The multiple prefabricated workpiece substrates may include a first workpiece substrate 12 and a second workpiece substrate 14. At least one of the first and second workpiece substrates 12, 14 is composed of a composite material. A variety of composite materials are possible, as will be explained in more detail below. The first and second workpiece substrates 12, 14 are joined together by a polymer joint 16. The polymer joint 16 comprises a structural engineering plastic that is insoluble in water. The structural engineering plastic may be a thermoplastic or a thermoset polymer and is formed in a local mold tool 42 (FIGS. 2-4) that is closeable over a limited extent of the first and second workpiece substrates 12, 14. The workpiece assembly 10 shown here is a side panel for an automotive vehicle, but of course the presently-disclosed method is applicable to other components within a motor vehicle as well as non-automotive applications.

Each of the first workpiece substrate 12 and the second workpiece substrate 14 may be composed of a composite material 18, 20 as shown in FIGS. 2-4. The composite materials 18, 20 include a polymer matrix 22 and a reinforcement phase 24 embedded within and dispersed throughout the polymer matrix 22. The composite materials 18, 20 may have the same or different composition. The polymer matrix 22 may be a thermoplastic or thermoset polymer. The reinforcement phase may be fibers, particles, or fibers and particles embedded in and distributed throughout the polymer matrix 22. While each of the first and second workpiece substrates 12, 14 is shown here as being comprised of the composite material 18, 20, is should be understood that one of the first or second workpiece substrates 12, 14 may be formed of the composite material 18, 20 while the other of the first or second workpiece substrates 12, 14 may be formed of a different material such as a metal including, for example, galvanized cold rolled steel, high-strength steel, or aluminum or an aluminum alloy.

A wide variety of thermoplastic and thermoset polymers may constitute the polymer matrix 22 of the composite materials 18, 20. For example, the polymer matrix 22 may be comprised of any of the following thermoplastics: polyvinyl chloride, polyvinylidene chloride, polyvinyl acetate, polyvinyl alcohol, polystyrene, acrylonitrile-styrene polymer, acrylonitrile-butadiene-styrene, polyacrylates, polymethacrylate, polyethylene including medium-density polyethylene (HDPE) and low-density polyethylene (LDPE), polypropylene, thermoplastic olefin resins, aliphatic polyamides (PA46, PA6, PA66, PA6/66, PA11, PA12, PA610), fully or partially aromatic polyamides, polyacetals, polybenzimidazole, polycarbonate, polyethylene terephthalate, polyethylene naphthalate, polybutylene terephthalate, polyphenyl ethers, polyphenylene oxides, polyphenylene sulfide, polyethersulfones, polyetherether ketones, polyether ketones, polyetherimides, polylactides, polyoxymethylenes, thermoplastic polyurethanes, or any combination or heteropolymer of any two or more of these materials. The polymer matrix 22 may also be comprised of any of the following thermosets: benzoxazine, bis-maleimide, cyanate ester polymers, an epoxy, a phenolic, polyacrylate (acrylic), polyimide, an unsaturated polyester, a polyurethane, vinyl ester, siloxane, polydicyclopentadiene, or any combination or heteropolymer of any two or more of these materials.

The fibers and/or particles that may be included within the polymer matrix 22 as the reinforcement phase 24 may also vary. Some examples of suitable reinforcement fibers that may be employed include carbon fibers, glass fibers (e.g., fiber glass, quartz), basalt fibers, aramid fibers (e.g., KEVLAR®, polyphenylene benzobisoxazole (PBO), and TWARON™ para-aramid synthetic fibers), polyethylene fibers (e.g., ultra-high molecular weight polyethylene (UHMWPE)), polypropylene fibers (e.g., high-strength polypropylene), boron fibers, ceramic fibers, polyester fibers, natural fibers (e.g., cellulose, cotton, flax, hemp, spider silk, etc), and combinations of any two or more of such fibers. Some examples of suitable reinforcement particles that may be employed include mineral particles such as calcium carbonate, talc, silica, wollstonite, clay (varieties of which include any of kaolin, smectite, hectorite, montmorillonite, bentonite, beidelite, saponite, stevensite, sauconite, nontronite, illite, and halloysites), calcium sulfate, carbon black, mica, glass platelets, hollow glass spheres, alumina trihydrate, magnesium hydroxide, titanium dioxide, and combinations of any two or more of such particles.

While a number of combinations of the polymer matrix 22 and the reinforcement phase 24 are possible, certain combinations may be more common or more preferred than others. Notably, in certain preferred embodiments, the polymer matrix 22 of either or both composite materials 18, 20 may include polyethylene, polypropylene, a thermoplastic olefin rein, an aliphatic polyamide (PA46, PA6, PA66, PA6/66, PA11, PA12, PA610), a fully or partially aromatic polyamide, a polyphenyl ethers or a polyphenylene oxide, if a thermoplastic is desired, or it may include an epoxy, a phenolic, an unsaturated polyester, or a vinyl ester, if a thermoset is desired. Additionally, the reinforcement phase 24 of each composite material 18, 20, if present, may preferably include fibers such as carbon fibers, glass fibers, basalt fibers and/or hemp, may preferably include particles such as calcium carbonate, talc, silica, wollastonite, carbon black, and/or hollow glass spheres, or some combination of the aforementioned fibers and particles. In one particular embodiment, the composite material 18, 20 of either or both of the first and second workpiece substrates 12, 14 may be sheet molding compound (SMC), which is a fiber-reinforced thermoset resin in which the fibers are typically glass or carbon and the thermoset resin is typically a polyester, vinyl ester, or epoxy resin.

Each of the first workpiece substrate 12 and the second workpiece substrate 14 is prefabricated prior to being joined. That is, each of the first and second workpiece substrates 12, 14 has undergone some type of forming procedure to introduce a specified three-dimensional shape to the workpieces 12, 14. For example, if composed of the composite material 18, 20, the first workpiece substrate 12 and/or the second workpiece substrate 14 may be compression molded or plastic injection molded into a particular shape, although other molding techniques are certainly possible. And, if composed of a metal, the first workpiece substrate 12 or the second workpiece substrate 14, whichever is not composed of a composite material, may be stamped, drawn, additively manufactured, formed via quick plastic forming, or otherwise deformed into a particular shape. The prefabrication of the first and second workpiece substrates 12, 14 may involve trimming or further processing of the workpiece substrates 12, 14 after their initial shaping.

The method for joining the first and second workpiece substrates 12, 14 to obtain the workpiece assembly 10 is illustrated generically in FIGS. 2-4. Referring initially to FIG. 2, the first and second workpiece substrates 12, 14 are brought into proximity with one another and aligned. The first workpiece substrate 12 includes a front surface 26, a back surface 28, and an edge surface 30 that connects the front and back surfaces 26, 28 across a thickness 120 of the first workpiece substrate 12. Similarly, the second workpiece substrate 14 includes a front surface 32, a back surface 34, and an edge surface 36 that connects the front and back surfaces 32, 34 across a thickness 140 of the second workpiece substrate 14. The front surfaces 26, 32 of the first and second workpiece substrates 12, 14 may be visible or show surfaces of the workpiece assembly 10 and, as a result, may be designated Class A surfaces. Such surfaces are typically aesthetically styled and exhibit a high degree of surface quality. The back and edge surfaces 28, 30, 34, 36 may be non-visible surfaces of the workpiece assembly 10. Here, the first and second workpiece substrates 12, 14 are oriented in a butt joint arrangement in which the edge surfaces 30, 36 are opposed and the first and second workpiece substrates 12, 14 do not overlap. To help preserve the show surfaces and facilitate joining, each of the front surfaces 26, 32 of the first and second workpiece substrates 12, 14 may define a cutout 38, 40 in which the front surfaces 26, 32 step down from a base section 26′, 32′ to an intermediate 26″, 32″ that extends out to the edge surfaces 30, 36. The cutouts 38, 40 reduce the thickness 120, 140 of the first and second workpiece substrates 12, 14.

Once the first and second workpiece substrates 12, 14 are located relative to each other, a local mold tool 42 is positioned into contact with the first and second workpiece substrates 12, 14. The local mold tool 42 encloses an edge portion 44 of the first workpiece substrate 12 and an edge portion 46 of the second workpiece substrate 14 and defines, in combination with the first and second workpiece substrates 12, 14, a mold cavity 48. The edge portions 44, 46 are terminal portions of their respective workpiece substrates 12, 14 that include the edge surfaces 30, 36 as well as the cutouts 38, 40 in this particular embodiment of a butt joint arrangement of the workpiece substrates 12, 14. In that regard, the edge portion 44 of the first workpiece substrate 12 and the edge portion 46 the second workpiece substrate 14 are contained within the mold cavity 48, and a gap 50 exists between and separates the edge portions 44, 46 and, more specifically, exists between and separates the opposed edge surfaces 30, 36 of the workpiece substrates 12, 14. The local mold tool 42 may be sealed against the front surfaces 26, 32 and the back surfaces 28, 34 of the workpiece substrates 12, 14 or it may permeably engage the front surfaces 26, 32 and the back surfaces 28, 34 to allow for venting. Interior portions 12′, 14′ of the first and second workpiece substrates 12, 14 situated inboard of the edge portions 44, 46 are not covered by the local mold tool 42.

The local mold tool 42 has a first mold plate 52 and a second mold plate 54 that are closeable (as indicated by the arrows in FIG. 2) and openable (as indicated by the arrows in FIG. 4) and around the edge portions 44, 46 of the first and second workpiece substrates 12, 14. The first mold plate 52 engages the front surfaces 26, 32 of the first and second workpiece substrates 12, 14 and the second mold plate 54 engages the back surfaces 28, 34. The first mold plate 52 includes a first engagement surface 56 that makes contact with and extends between the base sections 26′, 32′ of the front surfaces 26, 32 of the first and second workpiece substrates 12, 14 and across the gap 50 while maintaining a flush profile with the base sections 26′, 32′ of the front surfaces 26, 32. A flush profile is a profile that follows a direct and smooth extrapolation between the base sections 26′, 32′ of the front surfaces 26, 32 without any out-of-contour deviations. The second mold plate 54 is similar to the first mold plate 52 in that it includes a second engagement surface 58 that makes contact with the back surfaces 28, 34 of the first and second workpiece substrates 12, 14. The second mold plate 54 includes a setback portion 60 in which the second engagement surface 58 departs from the back surfaces 28, 34 to define a notch 62, 64 with the back surfaces 28, 34. The second engagement surface 58 within the setback portion 60 also extends across the gap 50 between the edge portions 44, 46 of the first and second workpiece substrates 12, 14.

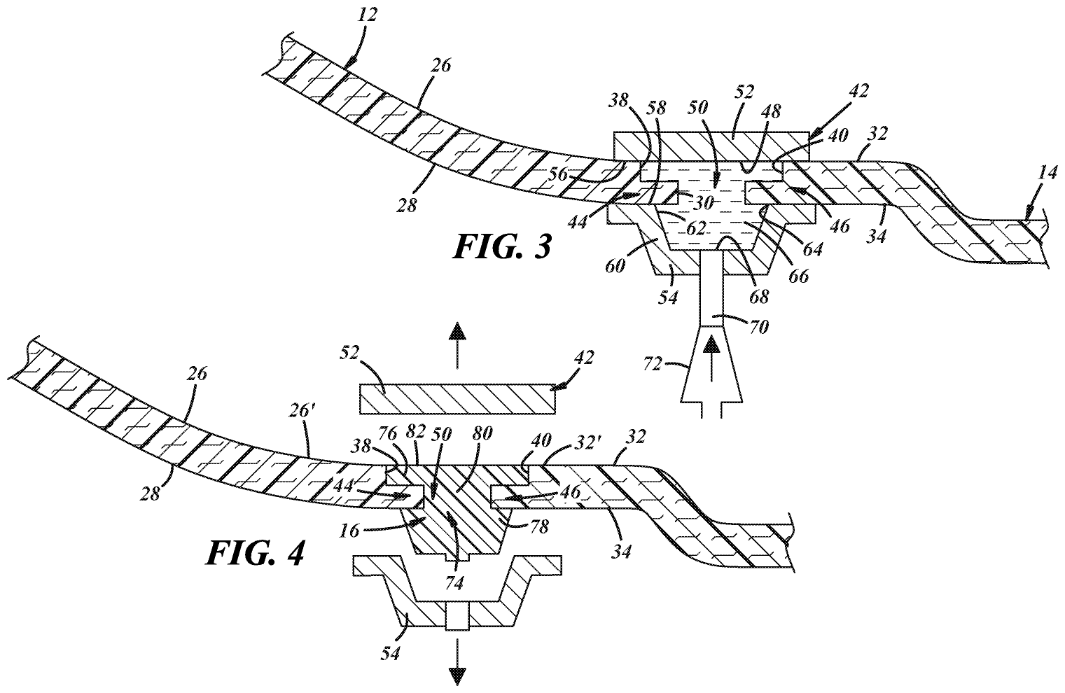

When the mold plates 52, 54 are closed around the edge portions 44, 46 of the first and second workpiece substrates 12, 14 and the local mold tool 42 is established and positioned, a liquid polymer molding compound 66 is injected into the mold cavity 48, as depicted in FIG. 3. The liquid polymer molding compound 66 is flowable and is any polymer or polymerizable composition from which a solid structural engineering plastic—either a thermoplastic or thermoset polymer—can be derived. The liquid polymer molding compound 66 is injected through an entrance 68 of a drop conduit 70 defined in the second mold plate 54 within the setback portion 60. The drop conduit 70 communicates with an injection head 72 that supplies the liquid polymer molding compound 66 through the drop conduit 70 at a suitable pressure. The injection head 72, moreover, may also be an impingement mixer in the event that components of the liquid polymer molding compound 66 need to be mixed prior to injection. Upon being injected, the polymer molding compound 66 flows through and fills the mold cavity 48 and, in doing so, contacts and surrounds each of the edge portion 44 of the first workpiece substrate 12 and the edge portion 46 of the second workpiece substrate 14 while also filling the gap 50 between the edge portions 44, 46 of the first and second workpiece substrates 12, 14. As a result of flowing around and surrounding the edge portions 44, 46, the polymer molding compound 66 fills the cutouts 38, 40 as well as the notches 62, 64.

The liquid molding compound 66 may be a polymer composition that comprises a thermoplastic polymer, which may optionally include dispersed fibers, particles, or fibers and particles. The polymer composition may be heated to a temperature above the melting temperature of the thermoplastic polymer when injected into the mold cavity 48. In this case, the thermoplastic polymer may be a polyamide such as polycaprolactam, also known as nylon 6 and PA6, poly(hexamethylene adipamide), also known as nylon 66 and PA66, or poly(caprolactam-co-hexamethylene adipamide), also known as nylon 6/66 and PA6/66, and the selection of the particular thermoplastic polymer may be based on compatibility with the polymer matrix 22 of the composite material(s) 18, 20 of the first and/or second workpiece substrates 12, 14. If fibers and/or particles are dispersed within the thermoplastic polymer, the fibers and the particles may be any of the fibers and particles disclosed above in connection with the composite materials 18, 20. When the polymer molding compound 66 includes a polymer composition that comprises a thermoplastic polymer, the first engagement surface 56 of the first mold plate 52, the second engagement surface 58 of the second mold plate 54, or both engagement surfaces 56, 58 may be compliant to non-sealingly engage its respective front and back surfaces 26, 32, 28, 34 of the first and second workpiece substrates 12, 14 and allow for venting.

The liquid polymer molding compound 66 may also be a polymerizable composition that polymerizes into a polymer within the mold cavity 48, which may optionally include the same types of dispersed fibers and/or particles mentioned above for the polymer composition. The polymerizable composition may include reactive polymerizable molecules—e.g., monomers, oligomers, and/or prepolymers—that are polymerizable into a thermoplastic polymer with or without the aid of a catalyst. For instance, the polymerizable composition may include caprolactam and an amount of water acting as a catalyst, which undergoes ring-opening polymerization to produce polycaprolactam when heated to a temperature of 250° C. to 260° C. When the polymer molding compound 64 includes a polymerizable composition—whether the composition polymerizes into a thermoplastic as disclosed above or polymerizes and cures into a thermoset as disclosed below—the first engagement surface 56 of the first mold plate 52 and the second engagement surface 58 of the second mold plate 54 may be sealed against their respective front and back surfaces 26, 32, 28, 34 of the first and second workpiece substrates 12, 14.

The polymerizable compound may include reactive polymerizable molecules that are polymerizable and curable into a thermoset polymer, and may additionally include a catalyst, a curing agent (hardener, chain extender, cross-linker, etc.), a diluent, and any other additives that may be needed to complete the polymerization and curing processes. For example, the polymerizable composition may include (i) a diisocyanate, such as hexamethylene diisocyanate (HDI) or isophorone diisocyanate (IPDI) or hydrogenated methylene diphenyl diisocyanate (HMDI), and (ii) a polyol, such as a hydroxyl-terminated polyether or polyester, along with (iii) a catalyst such as a ternary amine (e.g., 1,4-diazabicyclo[2.2.2]octane), which undergoes condensation polymerization and crosslinking when mixed together to form a polyurethane. In another example, the polymerizable composition may include (i) a diisocyanate, such as IPDI, and (ii) a polyamine, such as an amine-terminated ethylene or propylene oxide, along with low molecular weight chain extenders such as diethylenetriamine (DETA) or triethylene tetraamine (TETA) or a polyetheramine, which undergoes condensation polymerization and crosslinking when mixed together to form a polyurea. In yet another example, the polymerizable composition may include (i) a diepoxide such as epichlorohydrin, (ii) a diol or polyol such as bisphenol A or bisphenol F, and (iii) a polyfunctional amine, such as diethylenetriamine or triethylenetetramine, which undergo polyaddition (to form a polyepoxide such as diglycidyl ether of bisphenol A or bisphenol F) and crosslinking when mixed together to form an epoxy.

The liquid polymer molding compound 66 may be heated to its applicable temperature, if needed, prior to being delivered to the injection head 72 and injected into the mold cavity 48. Any mixing required of the liquid polymer molding compound 66 may also be performed in the injection head 72 under impingement mixing conditions. The heating of the liquid polymer molding compound 66 may entail heating the liquid polymer molding compound 66 or its individual components in a heat exchanger upstream of the injection head 72. The first and second mold plates 52, 54 may even be heated or cooled if desired to help manage the temperature of the liquid polymer molding compound 66 once received in the mold cavity 48. Since the liquid polymer molding compound 66 is typically heated only to moderate temperatures of 260° or less, and often 140° C. or less, a wide variety of materials are available for the construction of the first and second mold plates 52, 54, which can further help manage the temperature of the liquid polymer molding compound 66 once received in the mold cavity 48. For instance, the mold plates 52, 54 may be constructed from a thermally conductive rapid tooling material, such as zinc, aluminum, steel, or kirksite, so that heat can be expeditiously removed from the liquid polymer molding compound 66 to increase the speed at which it hardens within the mold, as described below. Other materials including a variety of composite materials may also be used to construct the mold plates 52, 54.

The liquid polymer molding compound 66 hardens within the mold cavity 48 to form the polymer joint 16, which is illustrated in FIG. 4. As noted above, the polymer joint 16 that results from the hardening of the liquid polymer molding compound 66 comprises a solid structural engineering plastic such as a polyamide, a polyurethane, a polyurea, or an epoxy. The hardening of the liquid polymer molding compound 66 occurs over a brief time period of, typically, less than 20 minutes, and the hardening mechanism depends on the composition of the molding compound 66. For instance, if the liquid polymer molding compound 66 includes a polymer composition such as PA6, PA66, or PA6/66, which is simply heated to a flowable molten state and injected into the mold cavity 48, the hardening process involves allowing the liquid polymer molding compound 64 to cool to a temperature below its melting temperature at which the polymer attains a semicrystalline state. This may occur over a period as short as 20 seconds to 60 seconds. If, however, the liquid polymer molding compound 66 includes a polymerizable composition that polymerizes into a thermoplastic polymer, or polymerizes and cures into a thermoset polymer, the hardening process involves allowing the exothermic polymerization reactions and the possible crosslinking activity to be completed over time at a specified temperature within the mold cavity 48. This may occur over a period of 2 minutes to 15 minutes in many instances. During this time, the polymerizable composition thickens and becomes more viscous as it transitions into the structural engineering plastic.

When the polymer joint 16 is fully hardened, the local mold tool 42 is opened by separating the first mold plate 52 and the second mold plate 54 from their respective front and back surfaces 26, 32, 28, 34 of the first and second workpiece substrates 12, 14, as shown in FIG. 4. The polymer joint 16 created in the disclosed joining method adheres the edge portion 44 of the first workpiece substrate 12 and the edge portion 46 of the second workpiece substrate 14 together. In particular, in the embodiment shown here in FIG. 4, the polymer joint 16 has a body 74 that assumes the shape of the mold cavity 48. To that end, the body 74 of the polymer joint 16 includes a first flange portion 76 that resides in the cutouts 38, 40 and second flange portion 78 that resides on the opposite sides of the workpiece substrates 12, 14 from the cutouts 38, 40 where the notches 62, 64 were present in the closed local mold tool 42. The body 74 further includes a central portion 80 that wraps around the edge portions 44, 46 of the workpiece substrates 12, 14 between the first and second flange portions 76, 78 to occupy the gap 50 between the edge portions 44, 46. The polymer joint 16 thus adherently joins the edge portions 44, 46 of the first and second workpiece substrates 12, 14 together while also mechanically interlocking the edge portions 44, 46 between the first and second flange portions 76, 78 of the body 74. Additionally, the first flange portion 74 includes an outer surface 82 that transitions smoothly and with a flush profile between the base sections 26′, 32′ of the front surfaces 26, 32 of the workpiece substrates 12, 14 to preserve the show surface quality of the front surfaces 26, 32.

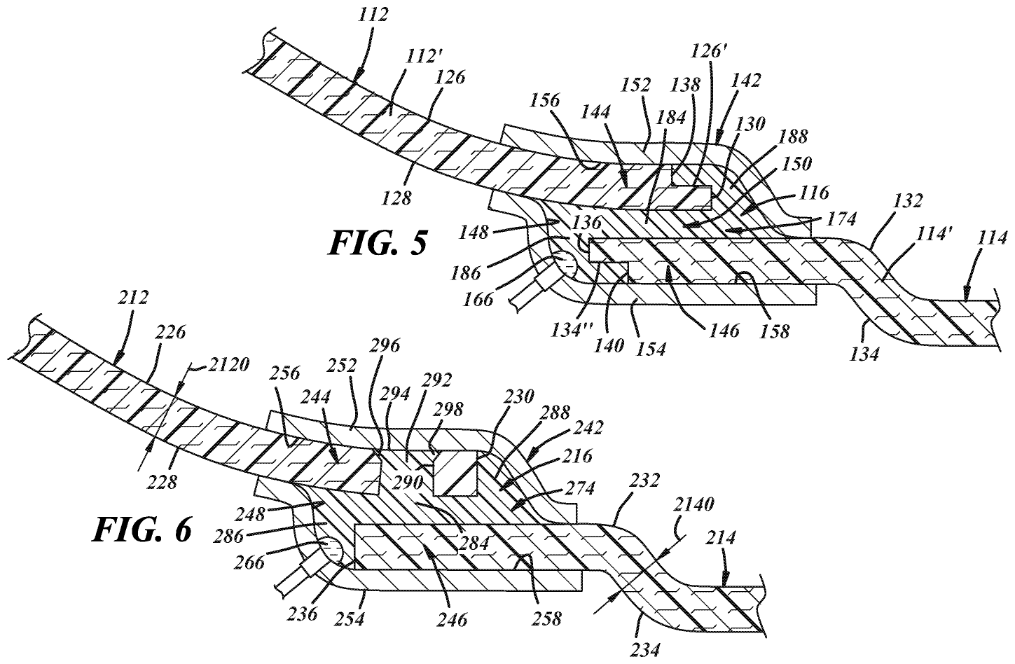

The disclosed joining method may be applied to different joint arrangements of the first and second workpiece substrates in addition to the butt joint arrangement described above without detracting from the spirit and objectives of the present disclosure. In the following discussion of alternate embodiments, reference numerals that correspond to the reference numerals used in the description of the previous embodiment will be used to identify the same or similar elements having the same or similar functionality. To that end, the description of aspects of the previously-described embodiment shown in FIGS. 1-4 apply equally to aspects of the following embodiments that are identified with corresponding reference numerals unless specifically described otherwise. Referring now to FIG. 5, the first and second workpiece substrates 112, 114 are oriented in a lap joint arrangement in which the edge portions 144, 146 of the workpiece substrates 112, 114 overlap. As shown here, the edge surface 130 of the first workpiece surface 112 extends beyond the edge surface 136 of the second workpiece substrate 114 such that back surface 128 of the first workpiece substrate 112 and the front surface 132 of the second workpiece substrate 114 confront while being separated by a gap 150. The edge portions 144, 146 of the workpiece surfaces 112, 114 may of course overlap in the opposite order.

In this embodiment, and similar to before, the local mold tool 142 is positioned into contact with the first and second workpiece substrates 112, 114 and encloses the edge portions 144, 146. The local mold tool 142 defines, in combination with the first and second workpiece substrates 112, 114, the mold cavity 148 in which the edge portions 144, 146 of the first and second workpiece substrates 112, 114 are contained. And again, as before, interior portions 112′, 114′ of the first and second workpiece substrates 112, 114 are not covered by the local mold tool 142. The local mold tool 142 may include a first mold plate 152 and a second mold plate 154 that have first and second engagement surfaces 156, 158, respectively, that make contact with the front and back surfaces 126, 132, 128, 134 (either sealingly or non-sealingly) of the workpiece substrates 112, 114. The front surfaces 126, 132 of the workpiece substrates 112, 114 do not necessarily have to include cutouts here since the edge portions 144, 146 overlap and the polymer joint 116 interleaves through the gap 150 established between the edge portions 144, 146. While the mold cavity 148 can be shaped in any number of ways, the engagement surfaces 156, 158 may be contoured so that the liquid polymer molding compound 166 injected into the mold cavity 148 contacts only the edge surface 130 and the back surface 132 of the first workpiece substrate 112 and only the edge surface 136 and the front surface of the second workpiece substrate 114.

The polymer joint 116 that adheres the edge portions 144, 146 of the first and second workpiece substrates 112, 114 together is formed from the liquid polymer molding compound 166 in the same way as before. Both the liquid polymer molding compound 166 and the polymer joint 116 are shown in FIG. 5 for brevity. Upon hardening from the liquid polymer molding compound 166, the polymer joint 116 includes a body 174 having a central portion 184 that occupies the gap 150 between the edge portions 144, 146 of the workpiece substrates 112, 114. Additionally, the central portion 184 of the body 174 and extends between opposed lip portions 186, 188 that are turned outwardly from the central portion 184 in opposite directions in adherent contact with their respective edge surfaces 130, 136. As such, similar to the previous embodiment, the polymer joint 116 adherently joins the edge portions 144, 146 of the first and second workpiece substrates 112, 114 together while also mechanically interlocking the edge portions 144, 146 between the first and second lip portions 186, 188 of the body 174.

Additional interlocking may be provided by defining a cutout 138, 140 in either or both of the workpiece substrates 112, 114 similar to before. The cutout 138 defined in the first workpiece substrate 112 may be the same as in the previous embodiment while the cutout 140 defined in the second workpiece substrate 114 involves a step down in the back surface 134 to an intermediate surface 134″ that extends out to the edge surface 136 of the edge portion 146. These cutout portions 138, 140 may be occupied by laterally extending wings of the lip portions 186, 188 of the body 174 such that the body 174 wraps around the edge portions 144, 146 of the workpiece substrate 112, 114. In a similar but slightly different variation, and as described above in connection with FIG. 4, the second mold plate 154 may be displaced from the back surface 134 of the second workpiece substrate 114 adjacent to the edge surface 136 so that the second engagement surface 158 departs from the back surface 134 to define a notch with the back surface 134. In this scenario, the body 174 of the polymer joint 116 wraps around the edge portion 146 of the second workpiece substrate 114 and includes a laterally extending wing off of the lip portion 186 in the same way as shown here in FIG. 5 with the exception that the cutout 140 need not necessarily be defined in the second workpiece substrate 114 since the polymer body 174 fills the notch defined between the back surface 134 of the second workpiece substrate 114 and the second mold plate 154. The first mold plate 152 may be similarly configured to form a notch between the front surface 126 of the workpiece substrate 112 and the first engagement surface 156 of the first mold plate 152.

In another alternate embodiment, and referring now to FIG. 6, the first and second workpiece substrates 212, 214 are oriented in a modified lap joint arrangement, sometimes referred to as a stitch joint arrangement. In this arrangement, the edge portions 244, 246 of the workpiece substrates 212, 214 overlap, as before with the lap joint arrangement, but one of the edge portion 244 of the first workpiece substrate 212 or the edge portion 246 of the second workpiece substrate 214 defines a series of holes 290 that traverse the thickness 2120/2140 of the workpiece substrate 212/214. The workpiece substrate 212/214 may include a chamfered surface 296 that surrounds the hole 290 and is adjacent with the front surface 226 (if the holes 290 are defined in the first workpiece substrate 212) or the back surface 234 (if the holes 290 are defined in the second workpiece substrate 214). One or both of the workpiece substrates 212, 214 may further include the cutouts or define a notch (neither shown here) with their respective mold plates 252, 253 described above for the same purpose if desired. The local mold tool 242 is positioned into contact with the first and second workpiece substrates 212, 214 and encloses the edge portions 244, 246, as before, while defining the mold cavity 248 in conjunction with the workpiece substrates 212, 214.

The local mold tool 242 may include a first mold plate 252 and a second mold plate 254 that have first and second engagement surfaces 256, 258, respectively, that make contact with the front and back surfaces 226, 232, 228, 234 (either sealingly or non-sealingly) of the workpiece substrates 212, 214. Moreover, if the series of holes 290 are defined in the first workpiece surface 212, as illustrated here in FIG. 6, the first engagement surface 256 of the first mold plate 252 may cover the holes 290 and be flush with the front surface 226 of the edge portion 244 of the first workpiece substrate 212 to preserve the show surface quality of the front surface 226. The polymer joint 216 that adheres the edge portions 244, 246 of the first and second workpiece substrates 212, 214 together is formed from the liquid polymer molding compound 266 in the same way as before, although here the body 274 of the joint 216 further includes a series of plugs 292 extending from the central portion 284, with a single plug 292 occupying each of the series of holes 290 defined in the workpiece substrate 212/214. The plugs 292 may have a radially outwardly extending flange 298 on an end opposite the central portion 284 of the body 274 of the joint 216. If the series of holes 290 are defined in the first workpiece substrate 212, for example, each of the plugs 292 may include an outer surface 294 that that extends across the flange 298 and transitions smoothly and with a flush profile across the front surface 226 of the workpiece substrate 212 to preserve the show surface quality of the front surfaces 226.

The polymer joint 216 thus adherently joins the edge portions 244, 246 of the first and second workpiece substrates 212, 214 together while also mechanically interlocking the edge portions 244, 246 between the first and second lip portions 286, 288 of the body 274 of the polymer joint 216, as in the previous embodiment, with additional mechanical interlocking being provided by the plugs 292, especially the flange 298 of the plugs 292. Indeed, in a slight alteration, and owing to the ability of the plugs 292 to provide mechanical interlocking, the engagement surfaces 256, 258 of the first and second mold plates 252, 254 may be contoured so that liquid polymer molding compound 266 injected into the mold cavity 248 contacts only the back surface 228 of the first workpiece substrate 212 and the front surface of the second workpiece substrate 214, thereby resulting in the body 274 of the polymer joint 216 having the central portion 284 and the plugs 292, but not the lip portions 286, 288.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of joining workpiece substrates to form a workpiece assembly, the method comprising:
positioning a local mold tool into contact with a first workpiece substrate and a second workpiece substrate, the local mold tool defining a mold cavity in conjunction with the first and second workpiece substrates and further enclosing an edge portion of the first workpiece substrate and an edge portion of the second workpiece substrate such that the edge portion of the first workpiece substrate and the edge portion of the second workpiece substrate are contained within the mold cavity;
injecting a liquid polymer molding compound into the mold cavity, the liquid polymer molding compound flowing through and filling the mold cavity and further contacting each of the edge portion of the first workpiece substrate and the edge portion of the second workpiece substrate; and
hardening the liquid polymer molding compound into a polymer joint that adheres the edge portion of the first workpiece substrate and the edge portion of the second workpiece substrate together.

2. The method set forth in claim 1, wherein the liquid polymer molding compound fills a gap between the edge portion of the first workpiece substrate and the edge portion of the second workpiece substrate when injected into the mold cavity.

3. The method set forth in claim 1, wherein at least one of the first workpiece substrate or the second workpiece substrate is composed of a composite material that comprises a polymer matrix and a reinforcement phase embedded within and dispersed throughout the polymer matrix.

4. The method set forth in claim 3, wherein each of the first workpiece substrate and the second workpiece substrate is separately composed of the composite material, the composite material of the first workpiece substrate and the composite material of the second workpiece substrate being the same or different.

5. The method set forth in claim 1, wherein the edge portion of the first workpiece substrate and the edge portion of the second workpiece substrate are oriented in a butt joint arrangement in which the edge portions are opposed but do not overlap.

6. The method set forth in claim 1, wherein the edge portion of the first workpiece substrate and the edge portion of the second workpiece substrate are oriented in a lap joint arrangement in which the edge portions overlap.

7. The method set forth in claim 6, wherein one of the edge portion of the first workpiece substrate or the edge portion of the second workpiece substrate defines a series of holes that traverse a thickness of the workpiece substrate in which the series of holes are defined.

8. The method set forth in claim 1, wherein hardening the liquid polymer molding compound results in the polymer joint comprising a solid structural engineering plastic selected from the group consisting of a polyamide, a polyurethane, a polyurea, and an epoxy.

9. The method set forth in claim 8, wherein the liquid polymer molding compound is a polymer composition that comprises a molten thermoplastic polymer heated to a temperature above its melting temperature.

10. The method set forth in claim 9, wherein hardening the polymer composition into the polymer joint comprises allowing the molten thermoplastic polymer to cool to a temperature below its melting temperature within the mold cavity.

11. The method set forth in claim 8, wherein the liquid polymer molding compound is a polymerizable composition that includes reactive polymerizable molecules that are polymerizable into a thermoplastic or a thermoset polymer.

12. The method set forth in claim 11, wherein hardening the polymerizable composition comprises allowing the reactive polymerizable molecules to polymerize within the mold cavity and, if a thermoset polymer is being formed, to also cure.

13. The method set forth in claim 1, wherein the polymer joint further mechanically interlocks the edge portion of the first workpiece substrate and the edge portion of the second workpiece substrate.

14. A method of joining workpiece substrates to form a workpiece assembly, the method comprising:
closing a first mold plate and a second mold plate to enclose an edge portion of a first workpiece substrate and an edge portion of a second workpiece substrate, the first mold plate and the second mold plate, when closed, defining a mold cavity in conjunction with the first and second workpiece substrates, and wherein the edge portion of the first workpiece substrate and the edge portion of the second workpiece substrate are contained within the mold cavity;
injecting a liquid polymer molding compound into the mold cavity, the liquid polymer molding compound flowing through and filling the mold cavity and further contacting each of the edge portion of the first workpiece substrate and the edge portion of the second workpiece substrate, the liquid polymer molding compound comprising (i) a polymer composition that includes a molten thermoplastic polymer or (2) a polymerizable composition that includes reactive polymerizable molecules that are polymerizable into a thermoplastic or thermoset polymer; and
hardening the liquid polymer molding compound into a polymer joint that adheres the edge portion of the first workpiece substrate and the edge portion of the second workpiece substrate together, the polymer joint comprising a solid structural engineering plastic selected from the group consisting of a polyamide, a polyurethane, a polyurea, and an epoxy.

15. The method set forth in claim 14, wherein each of the first workpiece substrate and the second workpiece substrate is separately composed of the composite material, the composite material of the first workpiece substrate and the composite material of the second workpiece substrate being the same or different.

16. The method set forth in claim 14, wherein the liquid polymer molding compound fills a gap between the edge portion of the first workpiece substrate and the edge portion of the second workpiece substrate when injected into the mold cavity, and wherein the polymer joint occupies the gap when the liquid polymer molding compound is hardened into the polymer joint.

17. The method set forth in claim 14, wherein the polymer joint further mechanically interlocks the edge portion of the first workpiece substrate and the edge portion of the second workpiece substrate.
